(19) United States
(12) Patent Application Publication
(10) Pub. No.: US 2026/0370010 A1
(43) Pub. Date: Nov. 19, 2026

(54) MULTIFUNCTIONAL INTELLIGENT CHARGING SOCKET DEVICE

(71) Applicant: Shenzhen Zhongke Hongrun Industrial Co., Ltd., Shenzhen (CN)

(72) Inventors: Wanhong QIAN, Shenzhen (CN); Tianwei TAN, Shenzhen (CN)

(73) Assignee: Shenzhen Zhongke Hongrun Industrial Co., Ltd., Shenzhen (CN)

(21) Appl. No.: 19/236,899

(22) Filed: Jun. 12, 2025

(30) Foreign Application Priority Data
May 13, 2025 (CN) 2025106148693

(51) Int. Cl. H02J 7/06; H02J 7/70; H02J 7/80; H02J 7/92

(52) U.S. Cl. CPC H02J 7/06; H02J 7/731; H02J 7/80; H02J 7/92

(57) ABSTRACT

The present application provides a multifunctional intelligent charging socket device, comprising a socket body, an AC input interface, more than one DC interface, and a power supply circuit arranged in the socket body. The power supply circuit comprises an MCU, more than one parallel first switching power supply circuit having an output end connected with the DC interface in one-to-one correspondence, and a power-off control module connected with an MCU control end for controlling the first switching power supply circuit to be turned off. The present application improves a performance of a network device connected with the DC interface.

### CROSS-REFERENCE TO RELATED APPLICATIONS

The application claims priority to Chinese patent application No. 2025106148693, filed on May 13, 2025, the entire contents of which are incorporated herein by reference.

### TECHNICAL FIELD

The present application relates to the field of socket structures, in particular to a multifunctional intelligent charging socket device.

### BACKGROUND

Network devices, such as routers, optical modems and other products, need external power supply, which generally runs continuously to provide users with network services. During the use of the network devices, the users will not take the initiative to restart operation. However, after long-term operation of the network devices, it is easy to cause system cache accumulation and affect performances of the devices.

Existing sockets are not designed with intelligent power supply sockets aiming at network devices generally. When problems of incapability of surfing the Internet and the like occur, the network devices need to be restarted manually to recover performances, particularly, an accommodating space is formed on a wall for the network devices, and the optical modem or even the routers may be stacked and placed in a special space, which will cause many inconveniences to the manual operations of the users due to the limited space.

### SUMMARY

In order to solve the problems in the prior art, the present application provides a multifunctional intelligent charging socket device.

The multifunctional intelligent charging socket device according to the present application comprises a socket body, an AC input interface arranged on the socket body and connected with commercial power, an AC power supply charging interface, more than one DC interface and a power supply circuit arranged in the socket body, wherein an input end of the power supply circuit is connected with the AC input interface, and an output end of the power supply circuit outputs power supply voltage to each charging interface respectively; the power supply circuit comprises more than one parallel first switching power supply circuit, a number of the first switching power supply circuit is the same as that of the DC interface, an output end of the first switching power supply circuit is connected with the DC interface in one-to-one correspondence, the power supply circuit also comprises an MCU, a first key switch and an indicating module respectively connected with the MCU, the power supply circuit also comprises a power-off control module for controlling the first switching power supply circuit to be turned off, and a control end of the power-off control module is connected with a control pin of the MCU; and the MCU controls regular restart of the first switching power supply circuit through the power-off control module, and a user controls a time interval of the regular restart through the first key switch, and the indicating module is used for indicating a set time interval duration.

Further, the socket body is further provided with more than one USB interface and a TYPE-C interface, and the power supply circuit further comprises more than one second switching power supply circuit arranged in parallel and respectively connected with the USB interface and the TYPE-C interface.

Further, the second switching power supply circuit comprises a power conversion unit and a fast charging protocol unit, an output end of the fast charging protocol unit is respectively connected with one USB interface and one TYPE-C interface, and the fast charging protocol unit adaptively adjusts a fast charging power of the USB interface and/or the TYPE-C interface according to conditions of external devices of the USB interface and the TYPE-C interface.

Further, a fast charging module integrating PD3.0+QC3.0 biprotocol is adopted in the power conversion unit.

Further, the multifunctional intelligent charging socket device further comprises a storage platform detachably connected with the socket body.

Further, a top surface of the socket body is provided with a first step surface and a second step surface higher than the first step surface, the second step surface is provided with an insertion groove, a lower surface of the storage platform is provided with a first boss matched with the first step surface, a back surface of the storage platform is provided with a second boss matched with the second step surface, a clamping latch is arranged in the second boss, an insertion channel is arranged between a side wall of the second boss and the clamping latch, and the clamping latch is capable of being inserted into the insertion groove to realize detachable connection between the storage platform and the socket body.

Further, an upper surface of the socket body is embedded in the first boss and the second boss, a first air duct is arranged between the second step surface and a lower surface of a top surface of the second boss, and a second air duct is arranged between a side wall of the second step surface and the side wall of the second boss.

Further, an upper surface of the first step surface is provided with a ventilation groove, a third air duct is respectively arranged between a surface and the side wall of the first step surface and a matching surface of the first boss, and the third air duct is communicated with the ventilation groove.

Further, the storage platform comprises a first platform arranged horizontally and a second platform arranged vertically to the first platform, and the first platform and the second platform are respectively provided with an anti-skid matrix consisting of a plurality of silica gel anti-skid structures.

Feurther, the first platform and/or the second platform is further provided with a fourth air duct for heat dissipation.

Compared with the prior art, the present application has the following beneficial effects: according to the present application, by setting the first switching power supply circuit, a special DC power supply is directly provided for the network device through the DC interface, and no additional power adapters are needed, thus effectively improving a utilization rate of the socket. By setting the MCU and a breakpoint control module, the network device can be managed intelligently, and a performance recovery rate of the network device can reach 92% when it is restarted regularly, which effectively improves an operating efficiency of the network device. The present application does not need manual operation during the whole process, and can run automatically, thus improving convenience.

By setting the storage platform, when charging a device, such as a camera, the device can be placed, which avoids the need to install a fixing bracket, and also avoids a problem of wiring for the device caused by that the charger needs to be pulled out for the installed device, which further improves a space utilization rate and appearance perception of the users, and a device concentration degree can be improved by more than 60%.

### BRIEF DESCRIPTION OF DRAWINGS

In order to illustrate the technical solutions in the embodiments of the present application or in the related art more clearly, the drawings used in the description of the embodiments or the prior art will be briefly described below. Obviously, the drawings in the following description are merely some embodiments recorded in the present application. For those of ordinary skills in the art, other drawings may also be obtained based on these drawings without going through any creative work.

FIG. 1 is a structural block diagram of a power supply circuit according to the present application;

FIG. 2 is a schematic circuit diagram of an embodiment of a first switching power supply circuit of the power supply circuit according to the present application;

FIG. 3 is a schematic circuit diagram of an embodiment of an MCU and an indicating module according to the present application;

FIG. 4 is a schematic circuit diagram of an embodiment of a second switching power supply circuit according to the present application;

FIG. 5 is a schematic circuit diagram of an embodiment of a fast charging protocol unit, a USB interface and a TYPE-C interface;

FIG. 6 to FIG. 8 are schematic structural diagrams of a multifunctional intelligent charging socket device according to the present application; and

FIG. 9 and FIG. 10 are schematic exploded structural diagrams of the multifunctional intelligent charging socket device according to the present application.

### DETAILED DESCRIPTION OF THE EMBODIMENTS

Unless otherwise defined, all the technical and scientific terms used in the embodiments of the present application have the same meanings as those commonly understood by those skilled in the art of the present application. Terms used herein in the specification of the present application are for the purpose of describing specific embodiments only and are not intended to limit the present application. The terms “including” and “provided with” and any variations thereof in the specification and claims as well as the above drawings of the present application are intended to cover non-exclusive inclusion. The terms “first”, “second” and the like in the specification and claims as well as the above drawings of the present application are used to distinguish different objects, and are not necessarily used to describe a specific sequence.

Reference in the present application to “an embodiment” means that a particular feature, structure, or characteristic described in connection with the embodiment may be included in at least one embodiment of the present application. The appearances of the phrase in various places in the specification are not necessarily all referring to the same embodiment, nor are separate or alternative embodiments mutually exclusive of other embodiments. It is to be expressly and implicitly understood by those skilled in the art that the embodiments described in the present application may be combined with other embodiments without conflict.

In order to make those skilled in the art better understand the solutions of the present application, the technical solutions in the embodiments of the present application will be described clearly and completely with the attached drawings.

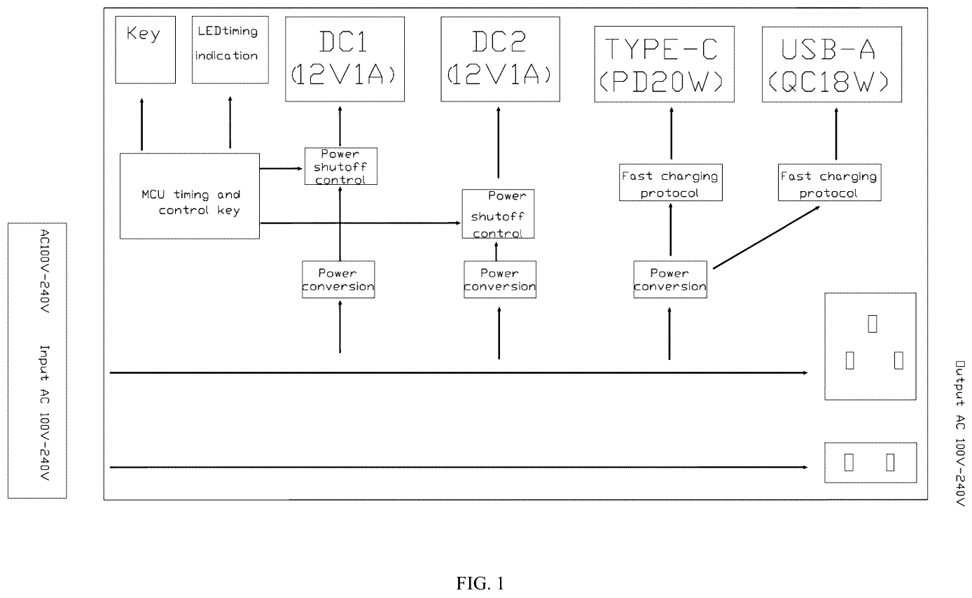

As shown in FIG. 1, an a preferred embodiment of the present application, a multifunctional intelligent charging socket device according to the embodiment comprises a socket body, and an AC input interface arranged on the socket body and connected with commercial power, used for inputting an 100V-240V AC power supply, and is further provided with one AC charging interface directly connected with the AC input interface, wherein the AC charging interface is provided with a two-hole interface and a three-hole interface to meet a power demand of an external AC electrical device. In this embodiment, two 12V 1 A DC interfaces, one group of fast charging interfaces (TYPE-C interface+USB-A interface) are additionally provided. The two 12V 1 A DC interfaces may be externally connected with optical modems and routers to provide basic network device power connection demands. The TYPE-C interface or the USB-A interface may be externally connected with chargers such as cameras. Five different charging interfaces meet power demands of almost all devices. Of course, numbers and types of the charging interfaces in this embodiment may be adapted and adjusted as needed.

The embodiment further comprises a power supply circuit arranged in the socket body, wherein an input end of the power supply circuit is connected with the AC input interface, and an output end of the power supply circuit outputs power supply voltage to each charging interface respectively. The power supply circuit comprises two parallel first switching power supply circuits and one second switching power supply circuit arranged in parallel with the first switching power supply circuits and connected with the USB interface and the TYPE-C interface respectively, and output ends of the first switching power supply circuits are connected with the DC interfaces in one-to-one correspondence.

The power supply circuit further comprises an MCU, a first key switch and an indicating module respectively connected with the MCU. The power supply circuit also comprises a power-off control module for controlling the first switching power supply circuit to be turned off, and a control end of the power-off control module is connected with a control pin of the MCU. The MCU controls regular restart of the first switching power supply circuit through the power-off control module, and a user controls a time interval of the regular restart through the first key switch, and the indicating module is used for indicating a set time interval duration.

The first key switch in the embodiment is a mechanical key or a touch key. Of course, the embodiment may also be set as a key group composed of multiple keys, corresponding to different duration adjustments. The indicating module in the embodiment is an LED timing indicator lamp, a number of which is the same as a number of different timing time, for indicating different durations. The indicating module in the embodiment may also be a display screen or a display tube.

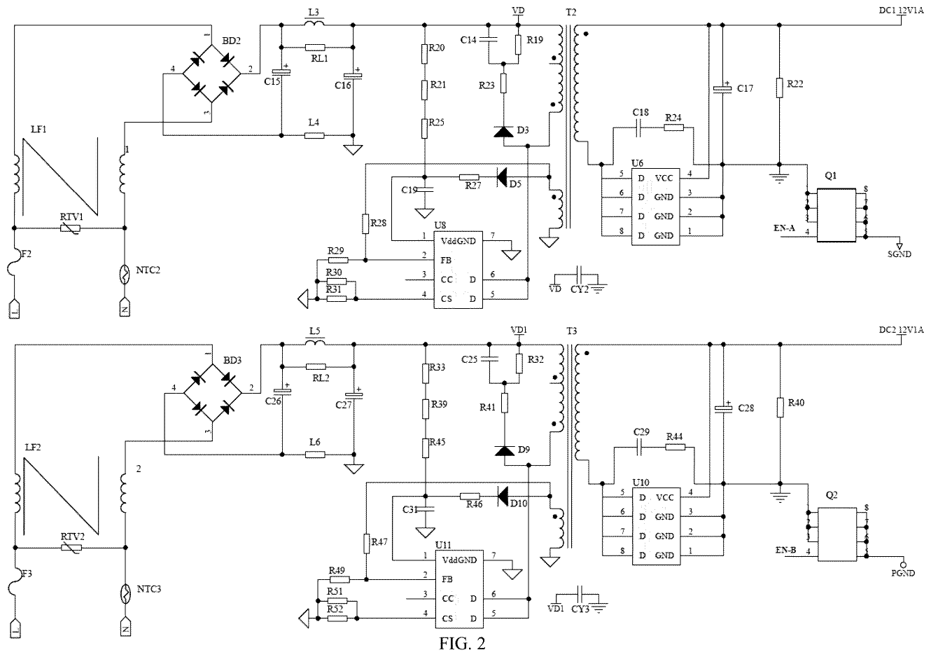

As shown in FIG. 1 and FIG. 2, the first switching power supply circuit in the embodiment converts an AC to a DC output by a rectifier BD2, and then forms a switching power supply by a power chip U8 and a power chip U6, providing a 12V 1 A power supply output for the DC interface at a later stage, wherein a common mode choke LF1 is used for suppressing electromagnetic interference, a thermistor NTC2 provides surge protection for the circuit, a varistor RTV1 provides lightning protection for the circuit, and short circuit and overcurrent protection are realized by connecting a fuse F1 in series on a live wire L.

The second first switching power supply circuit in the embodiment converts an AC to a DC output by a rectifier BD3, and then forms a switching power supply through a power chip U11 and a power chip U10, providing a 12V 1 A power supply output for the DC interface at a later stage.

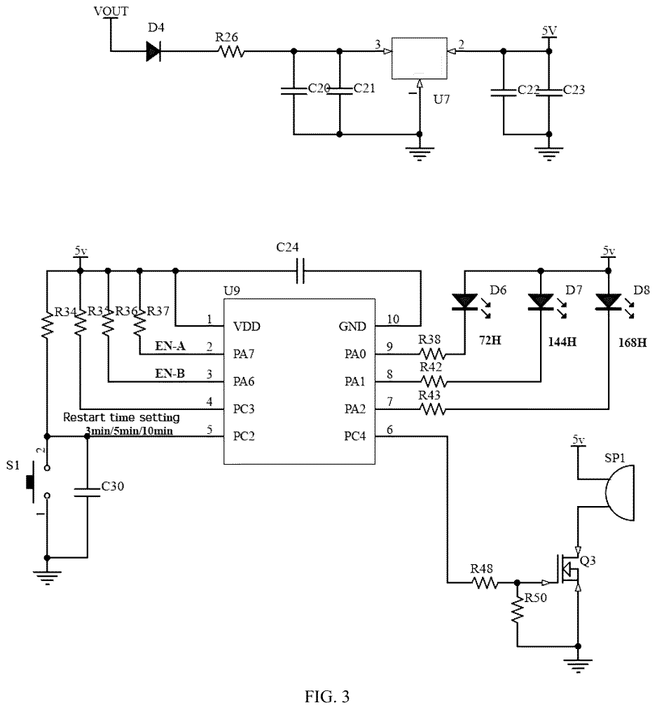

As shown in FIG. 2 and FIG. 3, an output end of the first switching power supply circuit in the embodiment is also provided with a switching transistor Q1, and an output end of the second switching power supply circuit is also provided with a switching transistor Q2. In the embodiment, a pin 2 of the MCU is connected with a control end of the switching transistor Q1 to form a power-off control module of the DC interface 1 together with the switching transistor Q1. When a restart time set by the U9 (MCU) reaches, EN-A will output a low level to make the switching transistor Q1 turn off an output voltage of the DC interface 1 to shut down the device. After the restart time, the EN-A will output a high level to turn on the Q1 to continuously supply power to the device. In the embodiment, a pin 3 of the MCU is connected with a control end of the switching transistor Q2 to form a power-off control module of the DC interface 2 together with the switching transistor Q2. When the restart time set by the U9 (MCU) reaches, EN-B will output a low level to make the switching transistor Q2 turn off an output voltage of the DC interface 2 to shut down the device. After the restart time, the EN-B will output a high level to turn on the Q2 to continuously supply power to the device.

In the embodiment, a pin 5 of the MCU is also connected with a key S1, and the restart time of the DC interface 1 and the DC interface 2 may be set. After the device is turned on, the DC interface 1 and the DC interface 2 are restarted every 72 hours by default by the U9 (MCU), and a corresponding LED lamp D6 lights up. Pressing the key once, the restart time will become to 144 hours, and the LED lamp D6 goes off, an LED lamp D7 lights up. Pressing the key again, the restart time will become to 168 hours, the LED lamp D7 goes out and an LED lamp D8 lights up in this cycle. The present application greatly facilitates operation of users through a key-type operation panel and concise and intuitive LED timing indicators.

Preferably, the embodiment is further provided with a beeper SP1 and a switching transistor Q3 for controlling the beeper SP1, and the MCU U9 will control the beeper SP1 to sound one minute before the DC interface 1 and the DC interface 2 are restarted. When the beeper sounds and the key S1 does not act, the DC interface 1 and the DC interface 2 will restart according to the set time. When the beeper sounds and the key S1 is pressed once, the DC interface 1 and the DC interface 2 will re-time without restarting. Pressing and holding the key S1 for a long time may turn off a restart function of the DC interface 1 and the DC interface 2, thus supplying power to the device all the time.

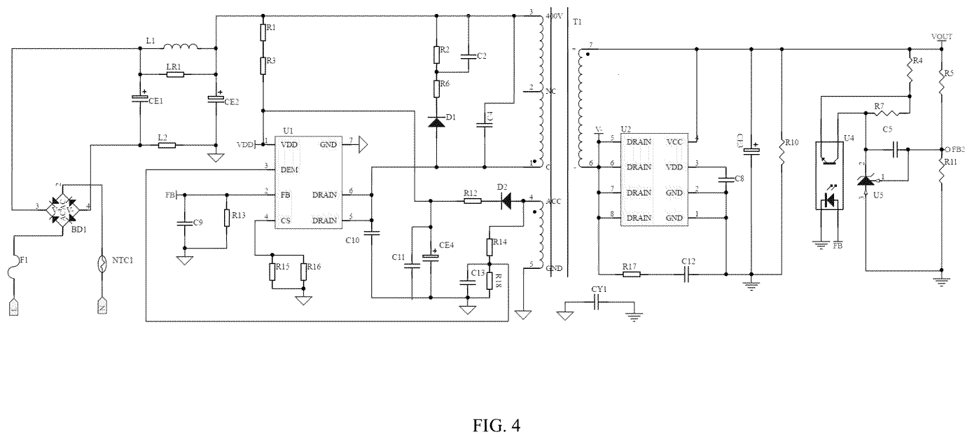

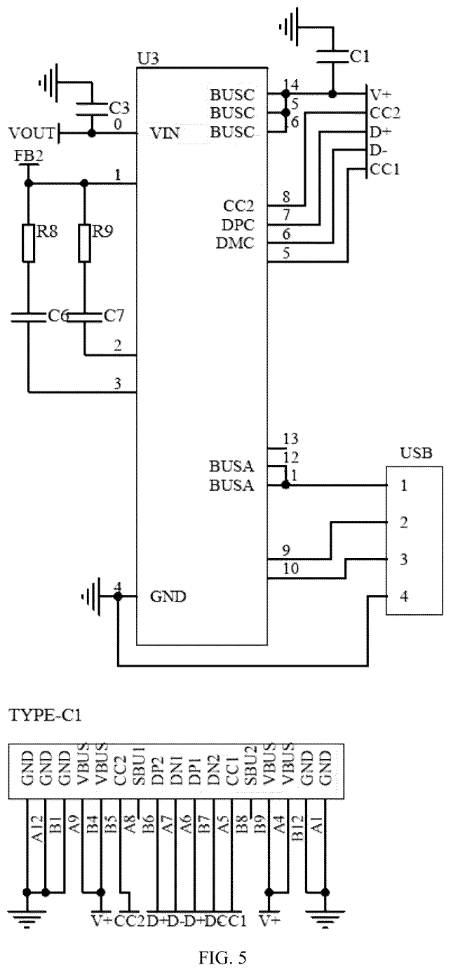

As shown in FIG. 1, FIG. 4 and FIG. 5, the second switching power supply circuit of the embodiment comprises a power conversion unit, and a fast charging protocol unit. An output end of the fast charging protocol unit is respectively connected with one USB interface and one TYPE-C interface, and the fast charging protocol unit adaptively adjusts a fast charging power of the USB interface and/or the TYPE-C interface according to conditions of external devices of the USB interface and the TYPE-C interface.

The power conversion unit in the embodiment comprises a rectifier DB1, power chips U1 and U2 and peripheral components thereof. The rectifier DB1 converts an AC to a DC output, the fuse F1 provides short-circuit and overcurrent protection, and the power chips U1 and U2 convert voltage to appropriate voltage output. A fast charging module U3 integrating PD3.0+QC3.0 biprotocol is preferably adopted in the fast charging protocol unit in the embodiment. An output end of the U3 is respectively connected with the USB interface and a TYPE-C interface TYPE-C1, which may provide a 20 W power for the TYPE-C1 and the USB interface. Singly used TYPE-C1 is PD 20 W, and singly used USB is QC18 W, and 5V3A MAX is used for output when the two are used together. The fast charging module U3 automatically adjusts an output voltage (5V/9V/12V) when detecting the access of a QC device. When a PD fast charging protocol device is accessed, 20 W power is used for charging via a CC wire.

The present application effectively solves technical problems that a traditional socket has a single function, and the network device and an intelligent terminal need to use multiple independent power adapters. By setting the first switching power supply circuit, a special DC power supply is directly provided for the network device through the DC interface, and no additional power adapters are needed, thus effectively improving a utilization rate of the socket. By setting the MCU and a breakpoint control module, the network device can be managed intelligently, and a performance recovery rate of the network device can reach 92% when it is restarted regularly, which effectively improves an operating efficiency of the network device. The present application does not need manual operation during the whole process, and can run automatically, thus improving convenience.

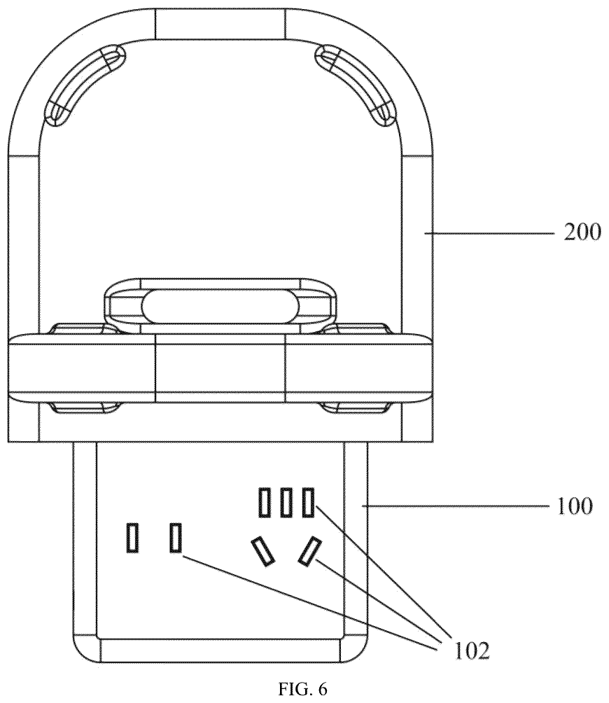

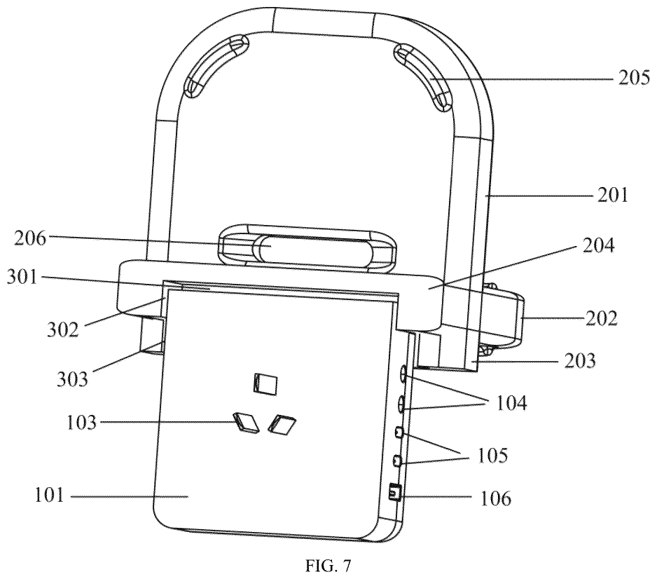

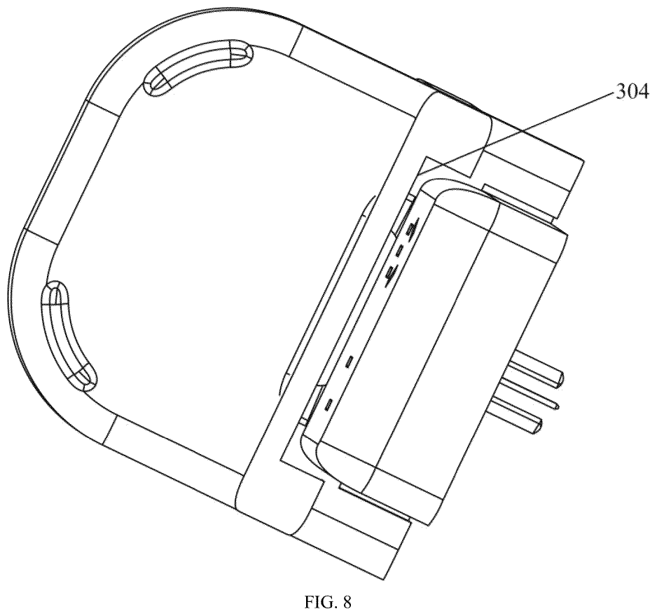

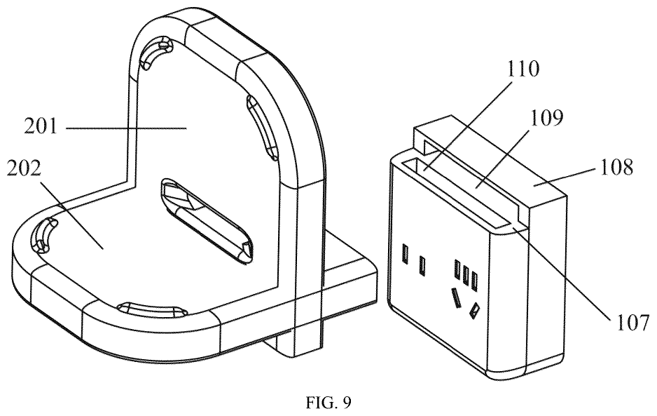

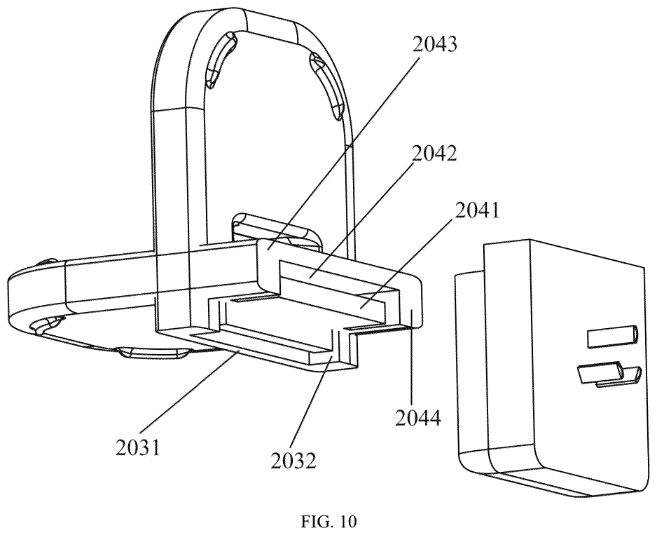

As shown in FIGS. 6 to 10, the multifunctional intelligent charging socket device in the embodiment further comprises a storage platform 200 detachably connected with a socket body 100 in addition to the socket body 100.

A top surface of the socket body 100 is provided with a first step surface 107 and a second step surface 108 higher than the first step surface 107. The second step surface 108 is provided with an insertion groove 109, a lower surface of the storage platform 200 is provided with a first boss 203 matched with the first step surface 107, a back surface of the storage platform 200 is provided with a second boss 204 matched with the second step surface 108, a clamping latch 2041 is arranged in the second boss 204, an insertion channel 2042 is arranged between a side wall of the second boss 204 and the clamping latch 2041, and the clamping latch 2041 is capable of being inserted into the insertion groove 109 to realize detachable connection between the storage platform 200 and the socket body 100. After the socket body 100 is fixedly connected with the storage platform 200, a back surface 2044 of the second boss 204 is flush with a back surface of the socket body 100. In the embodiment, a fixing structure such as adhesive may be arranged on the back surface 2044, so that the socket of the present application can be reinforced on a wall surface.

Preferably, an upper surface of the socket body 100 is embedded in the first boss 203 and the second boss 204, a first air duct 301 is arranged between the second step surface 108 and a lower surface of a top surface of the second boss 204, and a second air duct 302 is arranged between a side wall of the second step surface 108 and the side wall of the second boss 204.

Further, an upper surface of the first step surface 107 is provided with a ventilation groove 110, a third air duct 2032 is respectively arranged between a surface and the side wall of the first step surface 107 and a matching surface 2031 of the first boss 203, and the third air duct 2032 is communicated with the ventilation groove 110.

The storage platform 200 in the embodiment comprises a first platform 202 arranged horizontally and a second platform 201 arranged vertically to the first platform 202, so as to meet the storage requirements of vertical wall installation or flat insertion on a horizontal plane such as a desktop. In the embodiment, the first platform 202 and the second platform 201 are integrally arranged to improve an overall stability, and the first platform 202 and the second platform 201 are respectively provided with an anti-skid matrix consisting of a plurality of silica gel anti-skid structures 205, thus improving product placement stability. Preferably, the second platform 201 in the embodiment is further provided with a fourth air duct for heat dissipation 206. Of course, the fourth air duct for heat dissipation 206 may also be arranged on the fourth air duct for heat dissipation 206 to increase air circulation and enhance a heat dissipation performance. When vertically plugged into the wall surface, the second platform 201 in the embodiment keeps a certain distance from the wall surface through the second boss 204, and cooperates with the fourth air duct for heat dissipation 206 to improve a heat dissipation effect of the charger placed on the storage platform 200, thus overcoming the technical problems of poor heat dissipation and potential safety hazards caused by device stacking.

In addition, by arranging a plurality of air ducts at an interface between the socket body 100 and the storage platform 200, the present application can improve the heat dissipation effect when a plug is inserted into the charging interface for charging, and improve the safety of the socket body 100.

As an embodiment of the present application, the storage platform 200 of the embodiment preferably charges the network device and a home camera at the same time, thus overcoming the disadvantage that the home camera in the prior art cannot be placed on a wall and needs to be additionally installed with a fixing bracket, and also avoiding a problem of wiring for the device caused by that the charger needs to be pulled out for the installed device, which further improves a space utilization rate and appearance perception of the users, and a device concentration degree can be improved by more than 60%.

The specific embodiments described above are the preferred embodiments of the present application, and are not intended to limit the specific implementation scope of the present application. The scope of the present application includes but is not limited to the specific embodiment, and all equivalent changes made according to the present application are within the protection scope of the present application.

What is claimed is:

1. A multifunctional intelligent charging socket device, comprising a socket body, an AC input interface arranged on the socket body and connected with commercial power, an AC power supply charging interface, more than one DC interface and a power supply circuit arranged in the socket body, wherein an input end of the power supply circuit is connected with the AC input interface, and an output end of the power supply circuit outputs power supply voltage to each charging interface respectively;
the power supply circuit comprises more than one parallel first switching power supply circuit, a number of the first switching power supply circuit is the same as that of the DC interface, an output end of the first switching power supply circuit is connected with the DC interface in one-to-one correspondence, the power supply circuit also comprises an MCU, a first key switch and an indicating module respectively connected with the MCU, the power supply circuit also comprises a power-off control module for controlling the first switching power supply circuit to be turned off, and a control end of the power-off control module is connected with a control pin of the MCU; and
the MCU controls regular restart of the first switching power supply circuit through the power-off control module, and a user controls a time interval of the regular restart through the first key switch, and the indicating module is used for indicating a set time interval duration.

2. The multifunctional intelligent charging socket device according to claim 1, wherein the socket body is further provided with more than one USB interface and a TYPE-C interface, and the power supply circuit further comprises more than one second switching power supply circuit arranged in parallel and respectively connected with the USB interface and the TYPE-C interface.

3. The multifunctional intelligent charging socket device according to claim 2, wherein the second switching power supply circuit comprises a power conversion unit and a fast charging protocol unit, an output end of the fast charging protocol unit is respectively connected with one USB interface and one TYPE-C interface, and the fast charging protocol unit adaptively adjusts a fast charging power of the USB interface and/or the TYPE-C interface according to conditions of external devices of the USB interface and the TYPE-C interface.

4. The multifunctional intelligent charging socket device according to claim 3, wherein a fast charging module integrating PD3.0+QC3.0 biprotocol is adopted in the power conversion unit.

5. The multifunctional intelligent charging socket device according to claim 1, wherein the multifunctional intelligent charging socket device further comprises a storage platform detachably connected with the socket body.

6. The multifunctional intelligent charging socket device according to claim 5, wherein a top surface of the socket body is provided with a first step surface and a second step surface higher than the first step surface, the second step surface is provided with an insertion groove, a lower surface of the storage platform is provided with a first boss matched with the first step surface, a back surface of the storage platform is provided with a second boss matched with the second step surface, a clamping latch is arranged in the second boss, an insertion channel is arranged between a side wall of the second boss and the clamping latch, and the clamping latch is capable of being inserted into the insertion groove to realize detachable connection between the storage platform and the socket body.

7. The multifunctional intelligent charging socket device according to claim 6, wherein an upper surface of the socket body is embedded in the first boss and the second boss, a first air duct is arranged between the second step surface and a lower surface of a top surface of the second boss, and a second air duct is arranged between a side wall of the second step surface and the side wall of the second boss.

8. The multifunctional intelligent charging socket device according to claim 7, wherein an upper surface of the first step surface is provided with a ventilation groove, a third air duct is respectively arranged between a surface and the side wall of the first step surface and a matching surface of the first boss, and the third air duct is communicated with the ventilation groove.

9. The multifunctional intelligent charging socket device according to claim 5, wherein the storage platform comprises a first platform arranged horizontally and a second platform arranged vertically to the first platform, and the first platform and the second platform are respectively provided with an anti-skid matrix consisting of a plurality of silica gel anti-skid structures.

10. The multifunctional intelligent charging socket device according to claim 9, wherein the first platform and/or the second platform is further provided with a fourth air duct for heat dissipation.
